(19) United States
(12) Patent Application Publication
(10) Pub. No.: US 2007/0269303 A1
(43) Pub. Date: Nov. 22, 2007

(54) COMBINATION LOFT LADDER AND LIFT

(76) Inventor: Daniel Harry Corby Quare, Enfield (GB)

Correspondence Address: ANTHONY R. BARKUME, 20 GATEWAY LANE, MANORVILLE, NY, 11949, US

(21) Appl. No.: 11/564,534

(22) Filed: Nov. 29, 2006

(30) Foreign Application Priority Data
May 17, 2006 (GB) 0609771.1

(51) Int. Cl. B66F 9/06

(52) U.S. Cl. 414/785

(57) ABSTRACT

Apparatus is provided for lifting a load 30 through a hatch 10 through a floor or ceiling. A ladder 12 is fitted to one side of said hatch and extendable through and below the hatch. A lift carriage 32 fits onto the ladder for movement upwards or downwards along the ladder. A hoist 38 is attachable to the lift carriage via cable 34 for raising or lowering thereof. A frame 40, 42 for fitting to the floor or ceiling behind the hatch 10 has a movable portion 28 provided with a support for receiving the lift carriage on hoisting said lift carriage from said ladder through the hatch, The movable portion 28 is arranged on further hoisting of the lift carriage to pivot to from a lowered position where the support is in register with the top of the ladder to a raised position in which the lift carriage becomes located above and behind the hatch. In embodiments of the invention, at least one lock may be provided having an actuator member that becomes displaced from a working position when the movable portion is in its lowered position for control of the state of said lock and that is configured to lock the lift carriage to the movable portion when the movable portion is raised and to release the lift carriage from the movable portion when the movable portion is in its lowered position.

### FIELD OF THE INVENTION

The present invention relates to a apparatus and a method of mechanically loading or unloading large or heavy items into an elevated space. The invention has particular application in connection with the mechanical loading of large or heavy items into a loft through an existing loft hatch, whilst still allowing access to the loft through the same hatch by the user.

### BACKGROUND TO THE INVENTION

The main problem with lifting the large or heavy items is that it has to be carried at the same time as the person doing the lifting is climbing up the loft ladder. A separate pair of hands is required and at the same time as the goods are being lifted through the loft hatch, the person doing the lifting is also trying to get through the same aperture. Too many tasks need to be carried out by one person for the task to be achieved safely.

It is well known that the loading of large or heavy items into a loft space manually can be a difficult and frequently dangerous task. Many domestic accidents are ladder-related and causes include not setting ladders up properly, over-stretching because the user cannot be bothered to adjust the ladder position, and using both hands to lift the boxes above a user's head when loading the loft, leaving no hands free to hold the ladder. A separate lift can be installed in some instances but this is usually prohibitive on the grounds of cost or through lack of available space and a separate point of entry to the loft is usually required.

US-A-2005/0067223 (Penn) discloses a platform lift system includes a mounting frame that is fixedly engaged into a hatch formed in a horizontal supporting surface (i.e. attic floor or room ceiling) and a foldable ladder that is supported by the mounting frame. The mounting frame is flush with the ceiling floor to maximize available storage space within the attic ceiling. The ladder is broken into sections that are folded upon one another within the mounting frame to provide a generally compact structure when stowed, and are hingedly attached to the frame. When in the deployed position, the ladder sections are extended in alignment with each other to enable a user to access the attic space as with conventional attic access systems having a pull-down ladder. A separate trolley carries a lift platform that may be selectively raised or lowered in order to transport objects to/from the attic space. The trolley is moveable horizontally along a track that may be provided on a floor of the attic space. At a first end of travel of the trolley along the track, the trolley is disposed laterally alongside and vertically offset from the mounting frame so that the space above the mounting frame is unimpeded to permit a user to access the attic space using the deployed ladder. At a second end of travel of the trolley along the track, the trolley is aligned vertically with the mounting frame to permit use of the lift platform. The trolley further includes a drive system that controls the movement of four lift tethers that are coupled to corners of the platform, which can be raised by withdrawing the lift tethers, and can be lowered by paying out the lift tethers. The ladder has a track that provides a guide for movement of a lift platform, and the lift platform includes wheels at one end that run on the track.

By way of background, U.S. Pat. No. 5,911,287 (Campbell) discloses apparatus for lifting a load onto a roof of a building based on a sled that slideably contacts a ladder, and a lift cable by which the sled may be hoisted and lowered.

### SUMMARY OF THE INVENTION

The invention provides apparatus for lifting a load, comprising:

a hatch for a floor or ceiling;

a ladder fitted to one side of said hatch and extendable through and below the hatch;

a lift carriage for fitting onto the ladder for movement upwards or downwards along the ladder;

a hoist attachable to the lift carriage for raising or lowering thereof; and

a frame for fitting to the floor or ceiling behind the hatch having a movable portion provided with a support or otherwise configured for receiving the lift carriage on hoisting said lift carriage from said ladder through the hatch, said movable portion being arranged on further hoisting of the lift carriage to pivot to from a lowered position where the support is in register with the top of the ladder to a raised position in which the lift carriage becomes located above and behind the hatch.

For use with the apparatus as aforesaid, it also provides a frame for fitting to a floor or ceiling behind a hatch, said frame comprising:

a fixed portion for attachment behind the hatch;

a movable portion pivoted to the fixed portion and provided with a support or otherwise configured for receiving the lift carriage from the ladder,

said pivoting connection between the fixed and movable portions providing for movement between a lowered position where the support can register with the top of the ladder and a raised position in which the lift carriage becomes located above and behind the hatch.

For increased operational safety, there may be provided apparatus for lifting a load, comprising:

a hatch for a floor or ceiling;

a ladder fitted to one side of said hatch and extendable through and below the hatch;

a lift carriage for fitting onto the ladder for movement upwards or downwards along the ladder;

a hoist attachable to the lift carriage for raising or lowering thereof;

a frame for fitting to the floor or ceiling behind the hatch having a movable portion provided with a support or otherwise configured for receiving the lift carriage on hoisting said lift carriage from said ladder through the hatch, said movable portion being arranged on further hoisting of the lift carriage to pivot to from a lowered position where the support is in register with the top of the ladder to a raised position in which the lift carriage becomes located above and behind the hatch; and

at least one lock having an actuator member that becomes displaced from a working position when the movable portion is in its lowered position for control of the state of said lock, said lock being configured (a) to lock the lift carriage to the movable portion when the movable portion is raised and (b) to release the lift carriage from the movable portion when the movable portion is in its lowered position.

For use with the above further embodiment of the apparatus there may be provided a frame for fitting to a floor or ceiling behind a hatch, said frame comprising:

a fixed portion for attachment behind the hatch;

a movable portion pivoted to the fixed portion and provided with a support or otherwise configured for receiving the lift carriage from the ladder;

said pivoting connection between the fixed and movable portions providing for movement between a lowered position where the support can register with the top of the ladder to a raised position in which the lift carriage becomes located above and behind the hatch; and

the movable portion carrying a lock configured for locking a lift carriage thereto, said lock being configured so that it is operative when the movable portion is raised and is moved to a release position when the movable portion is in its lowered position.

Also provided for use with the above apparatus is a lift carriage, a movable frame portion configured to receive the lift carriage and at least one lock configured when the frame portion is lowered to lock the lift carriage onto the frame portion and configured to release the lift carriage when said frame portion is raised.

### BRIEF DESCRIPTION OF THE DRAWINGS

How the invention may be put into effect will now be described, by way of example only, with reference to the accompanying drawings, in which:

FIG. 1 is a diagrammatic perspective view of portions of a ceiling with a hatch formed therein, and lifting apparatus according to the invention fitted to the hatch;

FIG. 2 is a perspective view of a lift carriage and frame structure forming part of the apparatus of FIG. 1, the lift carriage being shown as it enters a support forming part of the frame;

FIG. 3 is a view similar to FIG. 2, but with the lift carriage having completed its movement into the support;

FIGS. 4 and 5 are views similar to FIGS. 2 and 3, but with a movable part of the frame structure partly raised and fully raised respectively;

FIG. 6 is a section of a ladder forming part of the apparatus of FIG. 1;

FIG. 7 is a perspective view of the lift carriage;

FIG. 8 is a diagrammatic perspective view of portions of a loft floor with a hatch formed therein and a second embodiment of the lifting apparatus fitted to the hatch, the lifting apparatus and a second embodiment of the lift carriage being shown in a partially raised position;

FIG. 9 is a view of the lift carriage and portions of the lifting apparatus of FIG. 8 in a lowered position;

FIG. 10 is a sectional view of the lift carriage and part of the lifting apparatus of FIGS. 8 and 9, again in the lowered position;

FIG. 11 is a perspective view of a third embodiment of the lifting apparatus and lift carriage, the lifting apparatus being in a fully raised position;

FIG. 12 is a view of the lifting apparatus and lift carriage of FIG. 11 in a partially lowered position of a parallelogram linkage forming part of said apparatus;

FIG. 13 is a partial view of the apparatus of FIGS. 11 and 12 in a fully lowered position of the parallelogram linkage forming part of said apparatus;

FIG. 14 is an end view of a guide member forming part of the ladder or lifting apparatus with a partial end view of the lift carriage;

FIG. 15 shows a remote control device;

FIG. 16 is a schematic side view of an automatic switching device; and

FIG. 17 is a schematic isometric view of the automatic switch device of FIG. 16.

### DETAILED DESCRIPTION OF PREFERRED EMBODIMENTS

The present invention overcomes the problems of the prior art lift devices by providing a means of fitting both a powered lift and a ladder that can operate in the same space. The user first places the load to be lifted onto a platform. The platform is preferably then pulled parallel to the ladder, through the loft hatch via the use of a cable. The cable passes over pulleys and is attached to a winch located in the loft space. The platform is then lifted clear of the hatch, enabling the operator to climb the ladder, pass through the hatch into the loft space and unload the platform. The operation can then be repeated as necessary or carried out in reverse to take loads safely from the loft down to a lower floor level.

The lift may be operated from either the lower floor level or from the upper floor/loft level or any other convenient position. The apparatus therefore has two main functions. Firstly it provides an easy method for accessing the loft via a set of folding steps which when stowed away fold neatly in to the loft. Secondly it allows for single-handed loading and unloading of boxes and other articles into and out of the loft using a remotely controlled hoisting mechanism. The mechanism keeps the load placed on the platform completely stable and level throughout the entire lifting process and can raise the load to a height within the loft that is easy to unload from without bending down thus preventing awkward bending to pick up an often heavy load.

Preferably the loft loader is configured so that an electromechanical winch hoists a trolley with a horizontal platform mounted to it up inside channels on the front side of the ladder. When the trolley reaches the top of the ladder it rolls into another section of channel mounted on a pivoting frame that moves the platform level further away from the hatch keeping the load level so that there is still space for the user to climb the ladder into the loft and unload the platform.

In one preferred embodiment the way in which the trolley rolls into another section of track is by using four wheels in line, on both sides of the trolley. When the first two wheels roll free from the channel on the front of the ladder, the remaining two wheels keep the trolley level in the channel and moving in the same direction so that it rolls across the gap and into small length of channel (with end stops) mounted on the mechanism in the loft.

The mechanism in the loft uses a pivoting four sided frame acting as a flexible parallelogram to ensure the load remains level during the lifting process. When the trolley reaches the end stops in the channel the electromechanical winch then hoists the trolley with attached platform using the pivoting parallelogram frame up and across into the loft keeping it level The user can then climb up the ladder and unload the platform which due to the design of the parallelogram frame is at an ideal height for unloading without bending down.

The use of a cut-out mechanism in the winch motor ensures that the lift will not lift more than the design load. It may be arranged to cut out should anything get trapped in the mechanism thus minimising the risk of injury and damage to the motor. The hoisting mechanism may be arranged to automatically shut off at both the bottom of the descent and the top of the ascent using proximity sensors. The person operating the lift can be made aware of this by the hand held control which will show an illuminated arrow in the direction of the platform's movement which will cut out when the platform reaches then end of its ascent or descent.

The invention has also other applications apart from lifting loads into a loft. It can be used for moving loads up and down floors in workshops, factories and storerooms as well as in outside applications.

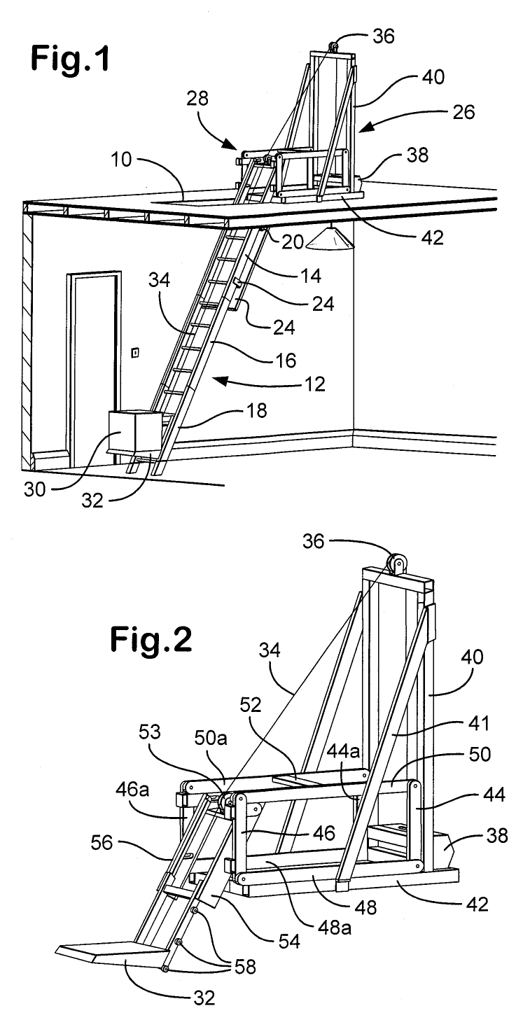

In FIG. 1, a hatch 10 in a ceiling has fitted thereto a folding ladder 12 formed of segments 14, 16 and 18 hinged together to form a straight continuous ladder as shown. The ladder segments may be folded up to overlie a trapdoor 24 hingedly connected to the hatch, the upper ladder segment 14 being attached to the trapdoor by brackets 20, 22. When folded away for storage the ladder rests neatly on top of the loft hatch and when unfolded ready for use the position of the hinges means that the roller tracks all align so that the trolley can run up and down freely. A wheeled lift platform 32 that can carries a load 30 runs in tracks formed in the sides of the ladder and can be hoisted or lowered by pulling in or paying out a lift rope or cable 34.

Above the ladder and behind the hatch 10 there is formed a frame structure having a fixed portion 26 and a movable portion 28. The fixed portion comprises a horizontal frame 42 that fits to the ceiling behind the hatch, extending away from the ladder as shown, and a portal structure 40 at the back of the frame 42 and braced to the frame 42 by struts 41 (FIG. 2). A motor 38 located on or immediately above the frame 42 pays out or pulls in the rope or cable 34 via a pulley 36 on a cross-member forming part of the portal structure.

As seen in FIG. 2, the movable part of the frame structure forms a pair of transversely spaced 4-bar parallelogram linkages comprising fixed rear members 44, 44a, front members 46, 46a, lower members 48, 48a and upper members 50, 50a, pivoted together as shown. The rear members 44, 44a are securely bolted to posts of the portal structure 40, and the two parallelogram linkages are held at the correct spacing by a spacer bar 52. A support 54 is fixed e.g. by bolts to the front members 46, 46a at a predetermined angle thereto corresponding to the angle which will be adopted by the ladder. It comprises a pair of side members whose shapes and spacing correspond to side members 12a, 12b of the ladder (FIG. 6) and which likewise have upstanding and in-turned flanges defining inwardly facing channels 56, and spacer members whose widths correspond to the ladder rungs. As the parallelogram linkage moves, the front links 46, 46a maintain their vertical attitude, and the support 54 also maintains a fixed attitude or angle relative to the front links. Slots may be provided as shown to enable the attitude of the support 54 to be adjusted within a predetermined range of travel, after which the bolts are tightened to fix the attitude of the support 54 relative to the front links.

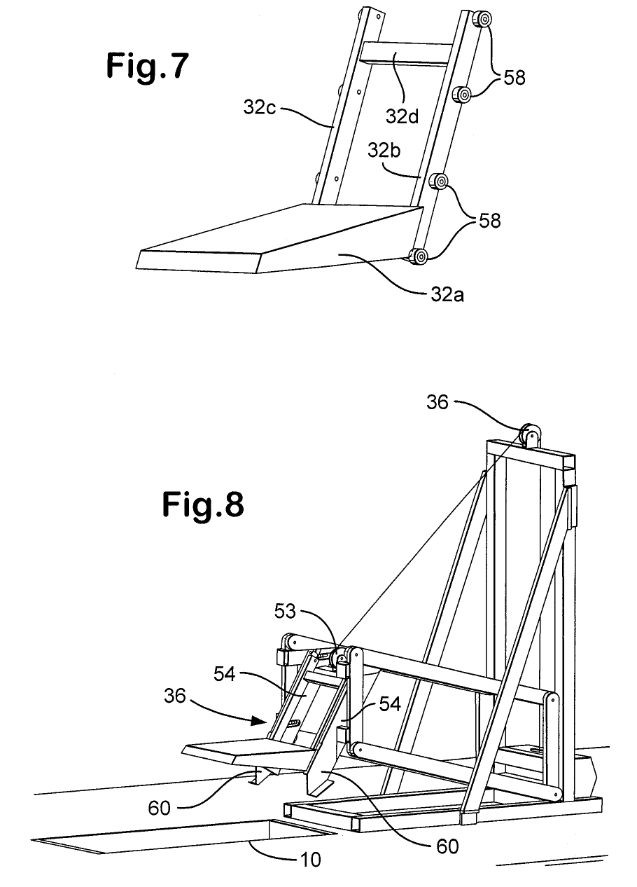

The lift carriage (FIG. 7) comprises a platform 32a, sides 32b, 32c, a top spacer 32d and four rollers 58 spaced along and projecting outwardly from sides 32b, 32c. When the lift carriage is on the ladder, the rollers 58 run in the side channels 56 and hold the carriage captive in the ladder. When the carriage 32 is lifted beyond the ladder, its rollers enter into corresponding channels 56 in the support 54, so that the carriage moves from the ladder to the support. The eight wheel system means that all times there are at least two wheels on each side of the trolley engaged in a track thus keeping it in the correct orientation ready for moving from one section of track to another. The four wheels or rollers 58 to each side of the lift carriage or trolley mechanism ensures that the lift carriage or trolley rolls freely from the ladder section of track into the support structure located in the parallelogram frame section 54. This happens when the trolley moves from the top of the ladder track into the parallelogram frame track ready to move up and away from the hatch. This also works in reverse. The eight wheel system means that all times there are at least two wheels on each side of the trolley engaged in a track thus keeping it in the correct orientation ready for moving from one section of track to another.

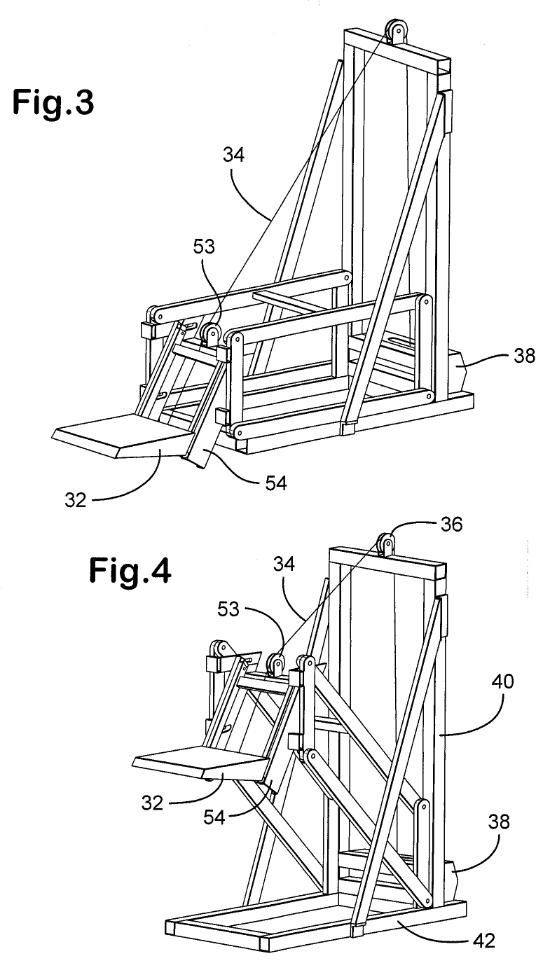

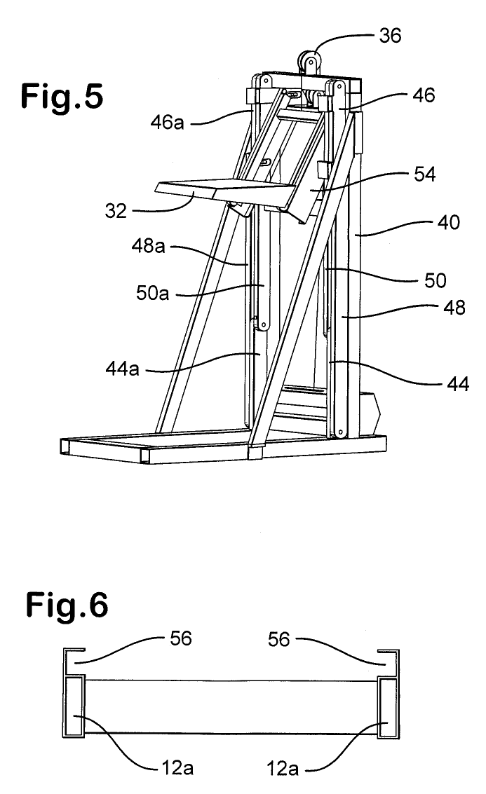

FIG. 3 shows the state where the carriage 32 has moved fully up into the support 54 where it contacts end stops, and continued pull on the rope or wire 34 has started to pull the movable part of the frame upwards, the wire being taken up by motor 38, pulley 36 and a further pulley 52 at the front of the movable part of the frame. The parallel linkages start to pivot upwards and fold as shown in FIG. 4, the front links 46, 46a and the support 54 maintaining the same attitude during pivoting motion because of the properties of the parallelogram linkage until the fully upright position of FIG. 5 is reached, where the links 48, 48a are upright and abut the posts of the portal structure 40. At this time the carriage has been moved clear of the hatch and also some distance above the hatch, typically waist height, so that loads can be removed from the load platform without the user having to bend to ground level. Furthermore, movement of the load requires only a single wire or cable to be attached to the lift carriage and the lift carriage has a continuous smooth movement path up the ladder, onto the support and to the fully raised position.

It will be appreciated that lowering a load through the hatch is the reverse of the procedure described above.

It will be seen therefore that this invention provides an efficient, safe and cost effective means of raising and lowering large or heavy goods through the same loft hatch as the access ladder. The present embodiment may use the following sequence of operations:
The operator can use the loft loader's steps independently of the loft loading mechanism if he just wants to access the loft space. The loft loader has an integrated set of deep tread aluminium steps which can fold out of the loft as do conventional loft ladders.
The operator activates the key operated switch to power up the loft loader.
The operator can then choose to operate the loft loader from the base of the steps or from within the loft itself. This is owing to the provision of multiple “plug in” locations (not shown) for the wired remote control.
Upon operating a down button on a remote control (not shown) the parallelogram mechanism lowers the platform keeping it level until it reaches the top of the steps where the lift carriage can run down inside the extrusions that form the sides of the ladder.
The lift platform keeps descending until it operates a kill switch at the bottom of its descent.
The same process is carried out in reverse during the platform's ascent. When the platform reaches the top of the ladder the parallelogram mechanism lifts the platform away from the hatch keeping it level until a kill switch is activated stopping the mechanism at its farthest point of travel. The operator can then ascend the steps and unload the platform.

In particular the embodiment described (which can be retro-fitted in existing homes) above has the following features and benefits:
a The loft loader folds away neatly into the loft hatch as do most conventional loft ladders.
It has been designed to fit between standard spaced ceiling joists.
It will lift up to 50 kg with a built in safety factor of double. The max recommended lifting weight of a human is 25 kg.
The loft loader may be provided with a key operated power switch. This safety feature prevents accidents by ensuring the loft loader cannot be operated by children who do not have a key.
The loft loader may be provided with an emergency stop button which means in the event of an accident the loft loader can easily be powered off.
An electronic control box for the drive motor may be provided with a current overload detector built in which means that if the winch stalls or an electrical fault occurs the loft loader powers off automatically.
The use of “kill” switches ensures that the loft loader's climb and descent is automatically controlled.
The loft loader lifts the load away from the hatch keeping it level so that the operator can climb up and unload the platform. Thus it enables single-handed operation.

Modifications may be made to the embodiment described above without departing from the invention. For example factories, workshops, offices and shops with either mezzanine floors or loft spaces may also largely benefit from the present ladder arrangement. Permanent standing versions could be installed if a fold away ladder is not desired. The rollers on the trolley could in fact be replaced with sliders i.e. they would remain in the channel as do the rollers but slide as opposed to roll. The above mechanism may also work with grooved rollers on the outside but it would be desirable to provide a design feature to ensure the lifting platform when loaded did not lever the trolley away from the ladder during operation. Also it is desirable that the rollers should be guided into the top mechanism smoothly.

For example, in some embodiments it may be advantageous to provide a lock that acts between the lift carriage and the movable portion of the frame, and that becomes operable by raising the movable portion of the frame so that when the lift carriage is in position on the movable portion of the frame and the movable portion of the frame is at least partly raised the lift carriage is held in position on the frame, and that is released by lowering the movable portion of the frame so that the lift carriage can be lowered from the frame. The lock may be changed between its locking and released states depending on whether an actuator member is in a working position or is displaced from the working position by contact with means defining a fixed surface when the movable portion of the frame is fully lowered. The fixed surface may, for example, be a region of floor or the like surrounding the hatch. Conveniently a pair of locks is provided one for each side of the lift carriage. The lock may engage with a roller of the lift carriage or it may engage with a catch member provided on the lift carriage. Operation of the lock may be by gravity, by a spring or by a combination of the two.

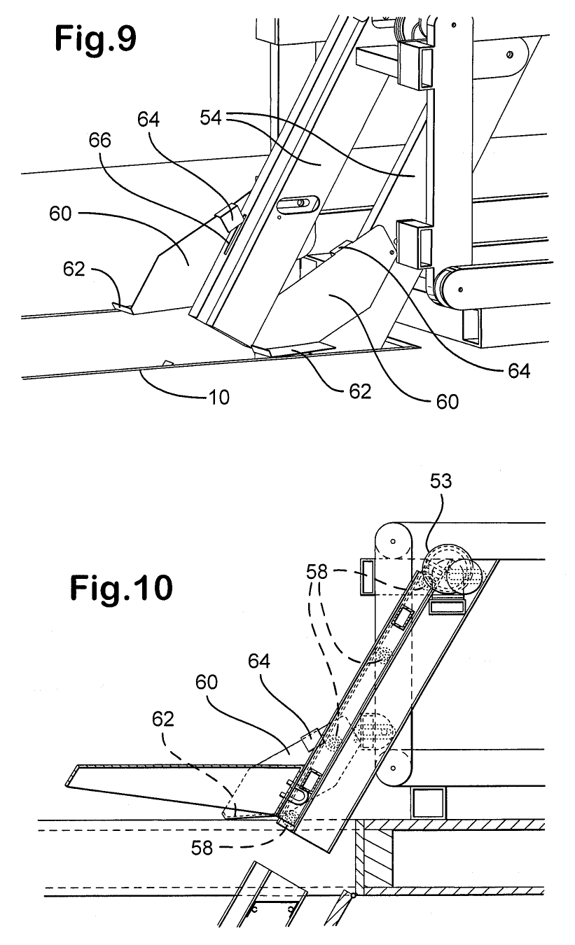

In FIGS. 8-10, there is provided a second embodiment of the lifting apparatus in which the support 54 to opposite sides of the frame has hinged thereto a pair of latch members 60 having actuator members or plates 62 that contact the floor around the hatch 10 as the movable part of the frame is in its fully lowered position. Locking tongues 64 are thereby lifted from slots 66 in the top flanges of support 54, as is apparent in FIG. 9. As the movable part of the frame is lifted, the latch members 60 are returned to their former position by gravity, returning the locking tongues 46 into engagement with rollers 58 of the lift carriage, thereby preventing the lift carriage from rolling off the frame. As the movable part of the frame is returned to its lowered position, contact between the floor and the actuator member 62 releases the latch. If desired, only a single latch could be provided, but it is preferable to provide a pair of them, one each side of the lift carriage as shown.

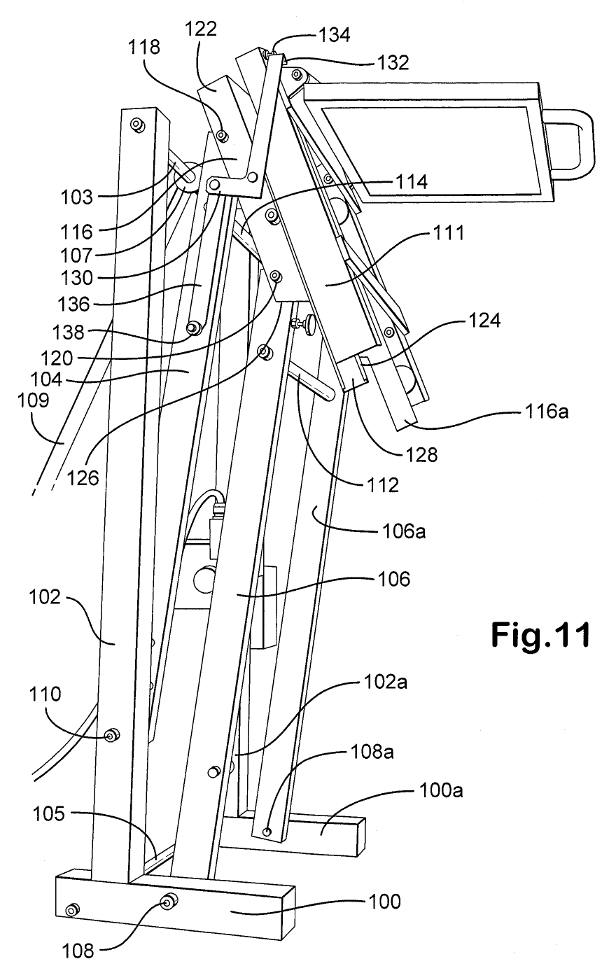

FIGS. 11-14 disclose a further embodiment of the invention which in addition to incorporating a further embodiment of the lock meets a number of additional needs. Problems have been encountered with the durability of aluminium ladders and both from the standpoint of durability and aesthetics it was desired to provide an embodiment based on or usable for a wooden ladder. From the manufacturing standpoint, it is preferable to minimize the component count, and in particular it was considered desirable to find a way of (a) using the fixed part of the frame structure to provide the rear parts of the parallelogram linkages and/or (b) at the front parts of the parallelogram linkages to provide single components that provide the functions of both the front links 46, 46a and the support 54. It was also desirable to reduce materials usage as regards other components.

In FIG. 11, a metallic fixed frame structure is defined by a pair of feet 100, 100a from which a pair of rigidly attached posts 102, 102a arises, the feet and posts being connected by upper and lower transverse spacer bars 103, 105. The rigid attachment is such that the angled support struts 41 shown in FIG. 2 can be dispensed with. This embodiment is designed, so far as possible, to be supplied in a disassembled flat-pack state and to be assembled on site. For that purpose the spacer bars 103, 105 may be attached between respective posts or feet by means of screws or bolts as shown. An advantage of this arrangement is that the spacer bars 103, 105 may be supplied in a range of lengths to accommodate different widths of hatch and ladder. The upper spacer bar carries a self-lubricating plastics roller 107 over which webbing 109 passes to lift carriage 111 for controlling rise and fall of the movable parts of the frame structure and of the lift carriage. Webbing is good for several reasons. Firstly it looks less industrial. Secondly in the unlikely event of an emergency it can be cut by a knife or by scissors. Thirdly it does not have the “cheese wire look” which may put some people off—especially from a finger trap point of view. Finally if there is any vibration in the webbing and it momentarily touches the wooden ladder then it should not damage the ladder, whereas a steel cable would eventually groove wood with which it can come into contact.

Lower parallelogram links 106, 106a are pivotally attached to the feet 100, 100a by means of fixings 108, 102a located at a spacing in front of the posts 102, 102a as shown, and are held at the desired transverse spacing by means of lower parallelogram spacer bar 112, the fixings 108, 108a and those for the spacer bar again being based on screws, bolts or the like to permit supply as a flat pack and local assembly. The spacer bar 112 may be supplied in a range of lengths corresponding to the lengths for the spacer bars 103, 105. Upper parallelogram links 104, 104a are pivotally attached to the posts 102, 102a by means of fixings 110, 110a located at a spacing above the feet 102, 102a as shown, and are held at the desired transverse spacing by means of upper parallelogram spacer bar 114, the fixings 110, 110a and those for the spacer bar 114 again being based on screws, bolts or the like. The spacer bar 114 is also supplied in a range of lengths corresponding to the lengths for the spacer bars 103, 105, 112. At the forward ends of the parallelogram links are front links 116, 116a pivoted to respective upper and lower parallelogram links at pivots 118, 120 which are again based on screws, bolts or other site-assemblable attachments. Each link 116, 116a is of channel section with a relatively deep web 122 (typical depth 10 mm) and a shorter out-turned flange 124 (typical width 25 mm). The web 122 is of full depth only where it interconnects the upper and lower parallelogram links, and forwardly and below the lower links 106, 106a the web has a cut-out 126 defining a less deep region 128 configured to pass through the hatch when the movable part of the frame defined by the parallelogram linkage is fully lowered. The out-turned flanges 124 which are typically of thickness about 3 mm provide rails for guiding movement of the lift carriage 111 onto and off the front of the movable part of the frame and for supporting the lift carriage in position. Their dimensions correspond to those of similar out-turned flanges on the ladder.

It will be noted that the rear link of each parallel linkage is defined by portions of foot 100, 100a and post 102, 102a between the pivot 108, 108a for the lower parallelogram link 106, 106a and the pivot 110, 110a for the upper parallelogram link 104, 104a. A line between each pair of pivots 108, 108a and 110, 110a in use faces away from the hatch at a ladder slope-like inclination to the vertical e.g. at an angle to the vertical of about 66°. Because of the properties of parallelogram linkages, the front links 116, 116a will be maintained at the same ladder-like angle, and there is no need to provide a separate support, which provides useful economy in parts inventory.

A bell crank member 130 is attached to each of the front links 116, 116a, being pivoted to webs 122 thereof. The upper end of each bell crank member has an in-turned latch bar 132 which locates beneath a projecting catch member 134 of the lift carriage 111 to hold the lift carriage in position on the movable part of the frame. A lower rearwardly facing portion of each bell crank member 130 has attached thereto a depending actuator member 136 which terminates in a roller 138.

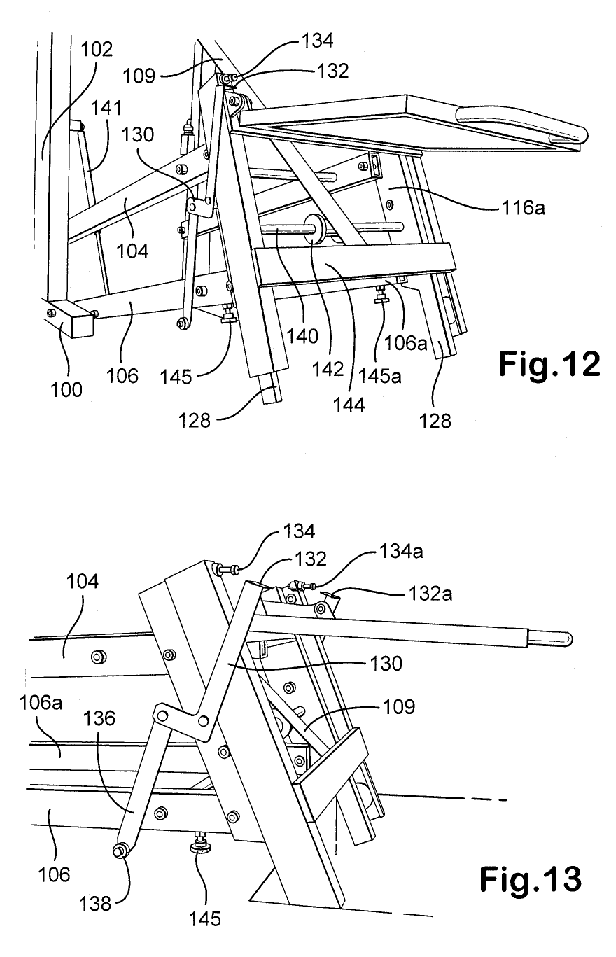

In FIG. 12, the movable part of the frame has moved most of the way towards its fully lowered position. Optionally the movable frame is controlled by a gas strut 141 connected by pivotal attachments e.g. between post 102 and lower parallelogram link 104 and assists descent of the parallelogram linkage as well as dampening its movement. However, the gas strut is optional and the apparatus will work effectively without it. A front link spacer bar 140 similar to those previously described carries roller or spool 142 for guiding webbing 109, especially during lowering of the lift carriage 111 from the movable part of the frame and down the ladder, the webbing being attached to cross-bar 144 of the lift carriage. The lower parallelogram links 106, 106a carry floor-contacting feet 145, 145a which define the lowermost position of the parallelogram linkage and which are screw-adjustable in height to cater for unevenness in the floor. FIG. 13 shows the movable part of the frame fully lowered into registration with the hatch and with feet 145 in contact with the floor to arrest downward movement of the linkage. Contact of the rollers 138 with the floor causes the bell crank members to rotate clockwise as viewed in FIG. 13 to withdraw the latch bars 132, 132a from engagement with the catch members 134, 134a and thereby permit the lift carriage to be lowered off the movable part of the frame under the control of the webbing 109.

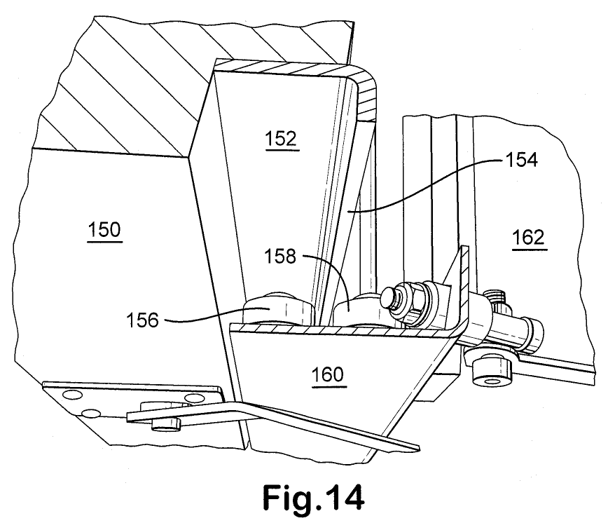

In FIG. 14 there is shown a detail of how the lift carriage runs on a wooden ladder (such ladders being popular). To either wooden side rail 150 of the ladder there are provided guide rails 152 of angle section e.g. in aluminium, the flanges 154 being outwardly directed. Similar flanges 124 are provided at the front of the movable frame where the lift carriage is to be received. The lift carriage has side members 160 of angle section e.g. in mild steel that carry upper and lower pairs of rollers that run on opposed sides of flanges 154. One of the pairs of rollers identified by reference numerals 156, 158 appears in FIG. 14. The rollers are at a spacing e.g. about 2 mm greater than the thickness of flange 154 so that if there is some misalignment between the ladder and the parallelogram members 122, 122a, the lift carriage 111 will still pass between the parallelogram linkage and the ladder. A platform 162 is supported towards the upper end of side members 160 and in the disclosed embodiment is pivoted at either side to the side members 160 of the lift carriage for rotation from its load-carrying positing shown in an anti-clockwise direction as viewed in FIG. 13 to a raised stowed position where it no longer obstructs the hatch 10 and is folded away when not in use.

Attachment of the angle-section guide rails 154 with their out-turned flanges permits retro-fitting of the present system to existing attic stairs or ladders.

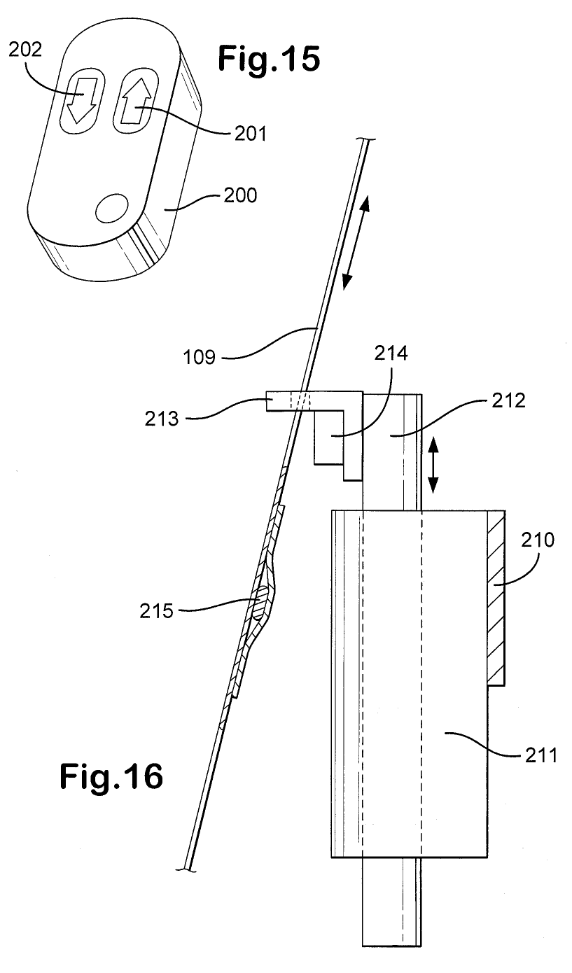

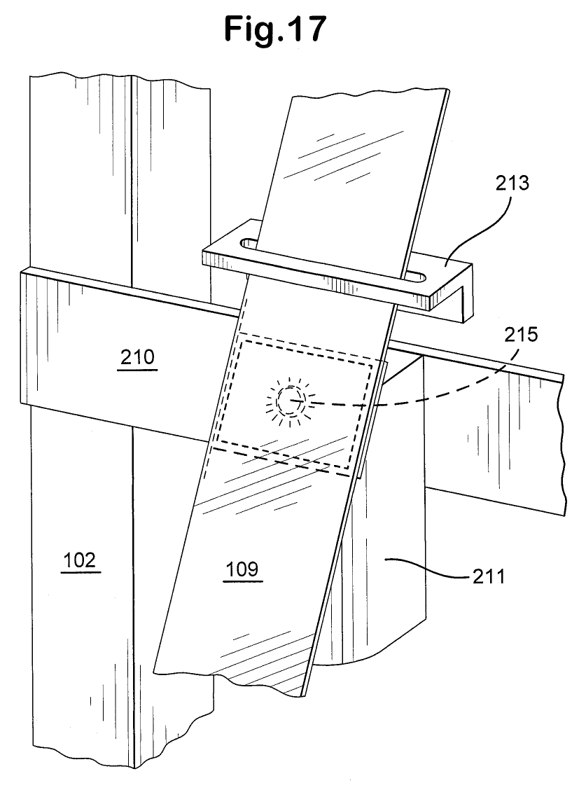

The hoist 38 in this second embodiment is controlled primarily by a remote control device 200 as shown in FIG. 15, which has up and down switches 201 and 202 respectively. Overrun of the hoist when the carriage 111 has reached its lowermost and its uppermost positions is prevented by the means shown in FIGS. 16 and 17. Attached to the rear of the frame 102 is a plate 210. Mounted on this plate 210 is a gate mount 211 in which freely slides a carrier 212 holding a gate 213 and a reed switch 214. The webbing 109 is arranged to pass through the gate except that the webbing carries a magnet 215 sewn thereto and which cannot pass through the gate. In the example shown, when the lift carriage 111 is approaching the lower floor, the magnet 215 reaches the gate 213 and, while lifting it in the carrier 212 activates the reed switch 214 which turns off the hoist 38. A similar magnet (not shown) attached to the webbing 109 operates the reed switch 214 when approaching the gate 213 in the opposite direction, when the lift carriage 111 is reaching its topmost position.

Also provided according to the invention is a kit of parts for fitting or retro-fitting to a ladder and hatch. It will in some embodiments include the frame which has fixed and movable portions as discussed, and a lift carriage for movement onto and from the frame, the frame and lift carriage optionally being provided with locking means for holding the lift carriage onto the frame when the movable part of the frame is other than in a lowered position.

Other embodiments will occur to those skilled in the art. For example it may be preferred to incorporate a locking device to lock the movable member to the frame in the raised configuration, such locking device perhaps controllable electrically by operation of the switch or perhaps by judicious location of the gas strut 141. However the mechanism including items 130, 132, 134 and 136 may be adapted to provide this locking device.

1. Apparatus for lifting a load up a ladder and comprising:
a lift carriage arranged for movement upwards or downwards along the ladder;
a hoist attachable to said lift carriage for raising or lowering thereof; and
a frame fittable to a floor adjacent the top of the ladder and having a movable portion configured to receive said lift carriage on hoisting said lift carriage from said ladder, said movable portion being arranged on further hoisting of said lift carriage to pivot from a lowered position where said movable portion is in register with the top of the ladder to a raised position in which said lift carriage becomes located above and behind the ladder.

2. Apparatus as claimed in claim 1 and wherein said lift carriage has wheels adapted for running on the ladder sides.

3. Apparatus as claimed in claim 1 and wherein said movable portion has carriage-receiving formations adapted to receive and retain said lift carriage thereto.

4. Apparatus as claimed in claim 1 and additionally comprising a ladder.

5. Apparatus as claimed in claim 4 and wherein said ladder has guide rails adapted to guide said lift carriage.

6. Apparatus as claimed in claim 5 and wherein said guide rails and said lift carriage have inter-engaging formations to hold said lift carriage captive when on the ladder.

7. Apparatus as claimed in claim 6 and wherein said guide rails have in-turned flanges defining a track and opposed sides of said lift carriage have outwardly projecting wheels that run in said track.

8. Apparatus as claimed in claim 6 and wherein opposed sides of the ladder have out-turned flanges defining a track and opposed sides of said lift carriage have inwardly facing wheels that run in said track.

9. Apparatus as claimed in claim 3 and additionally comprising a ladder, said movable portion being adapted to align with said ladder, whereby said lift carriage is smoothly moveable from said ladder onto said movable portion.

10. Apparatus as claimed in claim 1 and wherein said movable portion has distal and proximal ends and comprises four bar parallelogram linkages moveable between raised and lowered positions, the distal end of each said parallelogram linkage being configured to receive said lift carriage and the proximal end of each said parallelogram linkage being integral with a non-moving part of said frame.

11. Apparatus as claimed in claim 10 and wherein said proximal end of each parallelogram linkage is attached to the non-moving part of said frame at pivot positions such that said distal end in use aligns with an in place ladder, whereby said lift carriage is smoothly moveable from the ladder onto said movable portion.

12. Apparatus as claimed in claim 11 and wherein the inclination of said distal end, as defined by pivot positions thereof, is about 24° to the vertical.

13. Apparatus as claimed in claim 10 and wherein foot and post portions of a fixed part of said frame define said proximal end of each parallelogram linkage.

14. Apparatus as claimed in claim 10 and wherein said distal end of each parallelogram linkage has flanges configured for receiving said lift carriage.

15. Apparatus as claimed in claim 1 and further comprising at least one lock having an actuator member that becomes displaced from a working position when said movable portion is in its lowered position for control of the state of said lock and that is configured to lock said lift carriage to said movable portion when said movable portion is raised and to release said lift carriage from said movable portion when said movable portion is in its lowered position.

16. Apparatus as claimed in claim 15 and having a pair of said locks disposed to opposite sides of said lift carriage.

17. Apparatus as claimed in claim 15 and wherein said at least one lock is arranged for being urged by gravity towards its working position.

18. Apparatus as claimed in claim 15 and wherein said actuator member is configured to be displaced by portions of a floor adjacent said frame on lowering of said movable portion.

19. Apparatus as claimed in claim 15 and wherein said lock includes a latch pivoted to said frame.

20. Apparatus as claimed in claim 19 and wherein said lift carriage has wheel means and said latch is configured to engage said wheel means when said latch is in its working position.

21. Apparatus as claimed in claim 19 and wherein said lift carriage has a catch formation and said latch is configured to engage said catch formation when in its working position.

22. Apparatus as claimed in claim 1 and wherein said lift carriage incorporates a lift pallet.

23. Apparatus as claimed in claim 22 and wherein the raised position to which said movable portion is arranged to be moved is such that said pallet is about waist height to a standing user.

24. Apparatus as claimed in claim 1 and having automatic switch means controlling said hoist and arranged automatically to stop said hoist when said movable portion has reached its raised position.

25. Apparatus as claimed in claim 1 and having automatic switch means controlling said hoist and arranged to stop said hoist when said lift carriage has reached its defined lowest position.

26. Apparatus as claimed in claim 1 and having remote switch means controlling said hoist.

27. Apparatus as claimed in claim 1 and having webbing connected drivably between said hoist and said movable carriage.

28. Apparatus as claimed in claim 27 and having switch means on said frame and switch operating means on said webbing.

29. Apparatus as claimed in claim 1 and wherein said movable portion has adjustable feet.

30. Apparatus as claimed in claim 4 and wherein said ladder is attached to the floor to which said frame is fittable.

31. Apparatus as claimed in claim 30 and wherein said ladder is stowable.

32. Apparatus as claimed in claim 30 and wherein said ladder is collapsible.

33. Apparatus as claimed in claim 32 and wherein said ladder is collapsible telescopically.

34. Apparatus as claimed in claim 30 and wherein said ladder is foldable.

35. Apparatus as claimed in claim 30 and wherein said ladder is stowable adjacent the floor to which said frame is fittable.

36. Apparatus as claimed in claim 30 and wherein the floor defines a hatch adjacent which said frame is fittable and the top of said ladder is attached at the hatch.

37. Apparatus as claimed in claim 1 and having a gas strut operable to dampen movement of said movable portion.

38. Apparatus for lifting a load and comprising:
a frame fittable to a floor defining a hatch;
a movable portion to said frame;
a lift carriage having wheels and receivable by said movable portion;
a ladder having a top end and a bottom end, said top end being attached to the floor at the hatch, the ladder being engageable by said wheels and having guide rails adapted to hold said lift carriage captive when on said ladder;
a hoist mounted on said frame;
webbing attached between said lift carriage and said hoist and arranged drivably to raise and lower said lift carriage;
switch means operable to control said hoist, said switch means having a manually operable component and an automatic component, said automatic component comprising a switch on said frame and a device on said webbing operable to control said switch on said frame;
at least one lock operable to lock said lift carriage to said movable portion and comprising an actuator member;
said movable portion having distal and proximal ends and comprising four bar parallelogram linkages moveable between raised and lowered positions, the distal end of each said parallelogram linkage comprising a support member at said distal end thereof configured to receive said lift carriage and the proximal end of each said parallelogram linkage being integral with a non-moving part of said frame;
said movable portion being arranged on further hoisting of said lift carriage to pivot from a lowered position where said support member is in register with the top of said ladder to a raised position in which said lift carriage becomes located above and behind the batch; and
said actuator member being operable to become displaced from a working position when said movable portion is in its lowered position for control of the state of said lock and configured (a) to lock the lift carriage to the movable portion when the movable portion is raised and (b) to release the lift carriage from the movable portion when the movable portion is in its lowered position.

39. A kit of parts for fitting to a ladder and hatch and comprising:
a lift carriage configured to run along sides of a ladder;
a frame which has fixed and movable portions, said movable portions being controlled by parallelogram linkage means and configured to receive the lift carriage when raised from a ladder;
a hoist attachable to said frame;
a flexible member drivably attachable between said hoist and said lift carriage; and
switch means operable to control said hoist.

40. A kit as claimed in claim 39 and further comprising locking means operable to hold the lift carriage onto the frame when the movable portion of the frame is other than in a lowered position.
